(19) United States
(12) Patent Application Publication
(10) Pub. No.: US 2010/0126238 A1
(43) Pub. Date: May 27, 2010

(54) ANTI-THEFT DEVICE FOR EYEGLASSES AND PROCESS FOR ITS PREPARATION

(76) Inventor: Corrado Mazzucchelli, Grumello del Monte (IT)

Correspondence Address: NIXON & VANDERHYE, PC, 901 NORTH GLEBE ROAD, 11TH FLOOR, ARLINGTON, VA, 22203, US

(21) Appl. No.: 12/597,965

(22) PCT Filed: May 3, 2007
(86) PCT No.: PCT/IB07/01145

§ 371 Date: Oct. 28, 2009

(30) Foreign Application Priority Data
May 5, 2006 (IT) MI2006A000893

(51) Int. Cl. E05B 73/00; B23P 11/00

(52) U.S. Cl. 70/58; 29/428

(57) ABSTRACT

The present invention concerns an antitheft device of the type for mounting on the arm of a pair of glasses, comprising at least two rigid half shells able to close themselves over the arm, at least one half shell being provided with at least one insert in a pliable material able to accommodate, at least in part, a surface portion of the arm, and means to constrain said at least two half shells together in a non-reversible manner.

### FIELD OF INVENTION

The present invention concerns an anti-shoplifting (anti-theft) device for glasses and associated procedure for its manufacture. In particular, the anti-shoplifting device finds employment in shops or warehouses or anywhere where it is necessary to provide an antitheft device that discourages the theft of glasses and that, at the same time, is easily applied to the glasses and rapidly removable when they are sold.

### PRIOR ART

According to known art, these anti-shoplifting devices are positioned on the arm of the glasses and secured to it using suitable means of constraint that make it virtually impossible to free the antitheft device from the glasses other than through the use of an opportunely designed tool, used by the shop assistant when the glasses are sold. For example, in EP 1152111, in the name of the same applicant, an anti-shoplifting device is described that comprises a rigid base element provided with a bridge under which the arm of the glasses passes when it is in position. An opening is present on the top part of the bridge for housing a clamp screw that engages with the arm of the glasses by means of a flexible plate arranged below the bridge. This anti-shoplifting device is removed from the glasses by using a special tool able to operate the clamp screw, and can be immediately reutilized on other glasses, even if different in shape and size. Furthermore, the mentioned anti-shoplifting device offers the possibility of applying plaques carrying bar codes or other signalling systems, suitable for electronic detection, on the rigid base element, so as to reinforce the antitheft functions of the device itself.

In patent EP1041423, always in the name of the Applicant, an anti-shoplifting device for glasses, always mounted on an arm of the glasses, is described that comprises a rigid base shell which houses the arm of the glasses, a flexible element associable with the arm and anchorable to the rigid base, and means of constraint for clamping both the flexible element and the arm of the glasses to the rigid base plate. In this case as well, the said means of constraint comprise a screw that pushes the flexible element against the arm of the glasses, thereby anchoring it to the base plate. This device can also include a further element projecting from the base plate and facing the lens next to the arm on which the antitheft device is applied. In this way, the arm cannot be closed over the two lenses of the glasses, thus making theft of the object more difficult.

The above-mentioned anti-shoplifting devices, although allowing quick and rapid application and removal of the device on the glasses, are not devoid of drawbacks. In fact, the components that constitute these devices are either excessively numerous or shaped in a manner that is difficult to mould and/or assemble when the device is used. In fact, these device present numerous undercuts and both their production and their assembly are quite complicated and, in any case, can only be made in at least two distinct and separate phases, that of moulding and that of assembly. Both the above-described known devices are intended to be used more than once on different types of glasses. In practice, when the glasses are sold, the retailer opens the anti-shoplifting device with the specially provided tool and prepares it for use on another pair of glasses intended for display. Therefore, it appears clear that the more the devices are complex and formed of a certain number of pieces to be assembled, the more demanding becomes their repeated use. This, in fact, implies the need of adequately collecting all the components when the device is removed from the glasses, and also implies the need of retrieving all the components and correctly reassembling them when the device is to be used on other glasses.

Furthermore, it should be mentioned that although difficulties in using antitheft devices of the above-described type are not excessive in the case of retail sales in specialized shops, in the case of commercialization of glasses in the large-scale retail trade, where the recycling of the anti-shoplifting device from one pair of glasses to another can create some problems, devices of this type are quite inefficient and, in any case, create traceability problems.

### SUBJECT OF INVENTION

For these reasons, object of the present invention is to make a “disposable” anti-shoplifting device that is suitable for being positioned on the glasses, for example, by the manufacturer or the distributor of the glasses, and that, in addition, is easily to apply to the glasses and extremely difficult to remove without the use of a tool designed ad hoc just for that function.

A further object of the present invention is that of providing an antitheft device for glasses that has a simple shape and is structurally resistant so as to be simple to manufacture and easy to assemble.

Another object of the present invention is that of providing a method for making the antitheft device that, although providing for a moulding phase and a separate assembly phase, is simple, rapid and advantageous from the economic viewpoint.

Yet another object of the present invention is that of providing a method for making the antitheft device such that the moulding phase and that of assembly take place in a single operation.

### DESCRIPTION

These and other objects are achieved by the present antitheft device, of the type suitable for mounting on the arm of a pair of glasses, comprising at least two half shells that close onto the arm, at least one half shell being provided with at least one insert in a pliable material able to accommodate, at least in part, a surface portion of the arm; and means to constrain said at least two half shells together in a non-reversible manner when the device is mounted on the glasses, said at least one insert in a pliable material being compressed against the surface portion of the arm, between said at least two half shells.

According to a further aspect of the invention, the half shell and the insert in a pliable material can be made in a single piece and, in addition, each half shell can be fitted with at least one insert in a pliable material so that the arm remains inserted between at least two pliable inserts arranged on each of the at least two half shells.

In addition, in the case, for example, of a device made of two half shells according to the invention, the means to constrain the two half shells comprise one or more elements that can be coupled together by interference fitting. These anchor elements comprise at least one mushroom-shaped pin, arranged on a half shell and associable with at least one seat arranged on the other half shell. The seat is equipped with a deformable entrance end for the pin having smaller transversal dimensions than those of the free end of the pin. Furthermore, the seat comprises at least three elements projecting from the associated half shell, the end of which for inserting of the pin is fitted with a nose arranged facing the inside of the seat. Similarly, anchor elements of the above-described and equivalent type are also provided for, in the case of devices provided with more than two, always mutually associated, half shells.

In practice, the antitheft device can be made using at least two distinct materials, that is to say a rigid material for the half shells, such as a rigid plastic material for example, and a pliable material for the corresponding inserts, for example, a pliable plastic material with a high coefficient of friction.

According to the present invention, the half shells in a rigid material can, for example, be made of polycarbonate or fiberglass reinforced nylon, while the corresponding inserts in a pliable material could be made of rubber, silicone or any equivalent material.

In this way, when the antitheft device is completely closed over the arm of the glasses, with the pin of the means of anchorage inserted in the associated seat, the two inserts find themselves flattened and compressed against the two surface portions of the arm. The force of compression applied by the coupling prevents anyone from sliding the antitheft device along the arm or from opening the device without causing the breaking of the device itself or even of the arm.

A further advantage of the device forming the subject of the invention is represented by the fact that its closure in position on the arm of the glasses is easily achieved through simply applying pressure to its end. This pressure can be applied by hand or via the use of suitable tools, such as pliers, for example, or other tools normally available and accessible to everyone.

When the glasses are sold, the tool dedicated to opening the device is used in a straightforward manner by an ordinary shop assistant to open the device with extreme ease and, simultaneously with the opening, the antitheft device will become broken, making it unserviceable for subsequent use.

According to a further embodiment of the antitheft device, each half shell can be provided with at least one housing seat for the pliable insert and, in addition, the half shells are constrained such that they can rotate with respect to each other via a hinge situated at the ends of the half shells.

Lastly, it should be mentioned that the antitheft device can be moulded and assembled in a single phase, with everything taking place directly inside the mould. In fact, although the device is composed of two different materials, namely rigid plastic for the half shell and pliable plastic for the pliable insert destined to accommodate the arm of the glasses, each half can be produced in a single processing phase and a single piece, so that an almost finished piece comes directly out of the mould and there is no need to subsequently assemble the shell in rigid plastic and the insert in pliable plastic, for example, by gluing or similar. It is clear that in this way the dealer or the person who will apply the device to the glasses will be able to manipulate it in a rapid and simple manner, without the need to assemble a number of different components. In this case, the device is not made through gluing components or different elements, but by the precise union between insert and shell obtained directly during the moulding phase, thereby avoiding that the parts of which the device is composed subsequently come apart.

Alternatively, in the case where the device is instead made according to a procedure that provides for a moulding phase and a separate assembly phase, it will be possible to couple each half shell to each corresponding insert according to traditional methods, for example, by gluing or similar. This coupling can be carried out directly by the manufacturer of the device, or even by third party purchasers when the device is used as an anti-shoplifting device according to the invention.

### BRIEF DESCRIPTION OF FIGURES

Some special embodiments of the present invention will now be described, purely by way of non limitative example, with reference to the attached figures, where:

FIG. 1 is a perspective view of the antitheft device according to the invention, still open;

FIG. 2 is a side view of the antitheft device in FIG. 1, during the closure phase on the arm of a pair of glasses;

FIG. 3 is a top view of the antitheft device;

FIG. 4 is a side view of the antitheft device in accordance with a second embodiment of the invention;

FIG. 5 is a perspective view of the antitheft device in FIG. 4, still open;

FIG. 6 is a side view of a key suitable for opening the device shown as an example in FIG. 3;

FIG. 7 is a perspective view of the antitheft device according to the invention, provided with a plaque for the application of bar codes or various types of information;

FIG. 8 is a bottom view of the same device in FIG. 7;

FIG. 9 is also a bottom view of a device similar to that shown FIG. 7; while

FIG. 10 shows a perspective view of a key similar to that shown in FIG. 6 and suitable for opening the device shown as an example in FIG. 7.

With particular reference to these figures, the generic antitheft device according to the invention is designated by reference numeral 1.

The antitheft device 1 comprises two rigid half shells 2 and 3 constrained in rotation with respect to each other by a hinge 4 arranged on the ends 5 and 6, of the respective half shells 2 and 3. Each half shell 2 or 3 is made with a substantially parallelepiped shape and includes a housing seat 7 for an insert 9, the latter made of a pliable material and with a block-like shape.

It should be noticed that while the shells are made of a material, such as polycarbonate for example, which is substantially undeformable, the inserts are made of a flexible material, such as rubber or silicone for example, and also endowed with a high coefficient of friction.

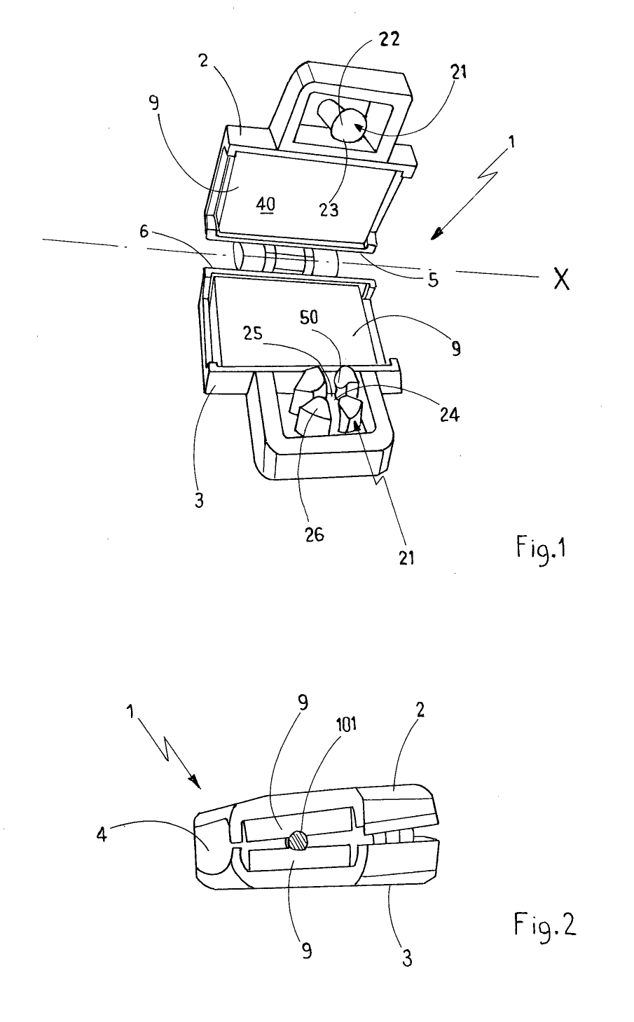

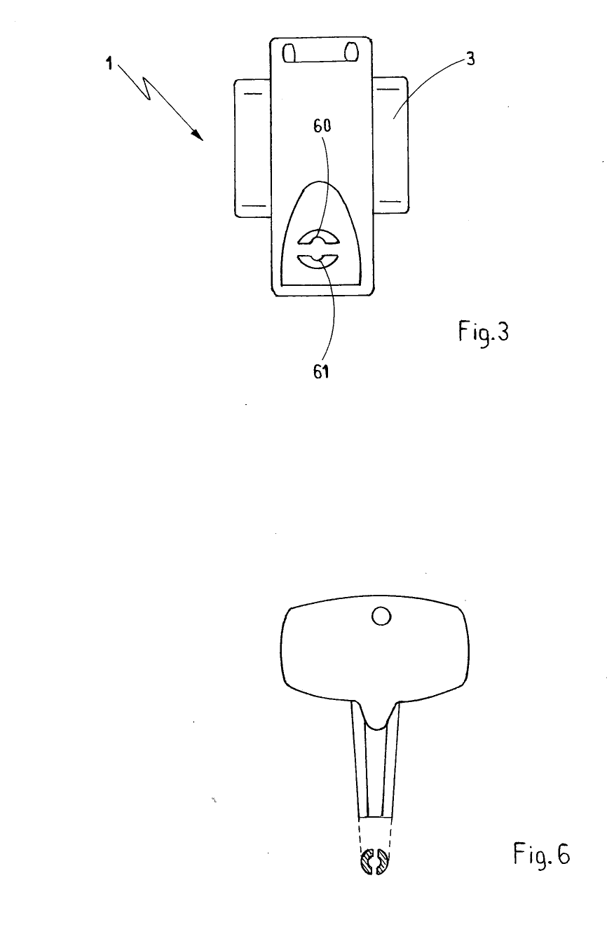

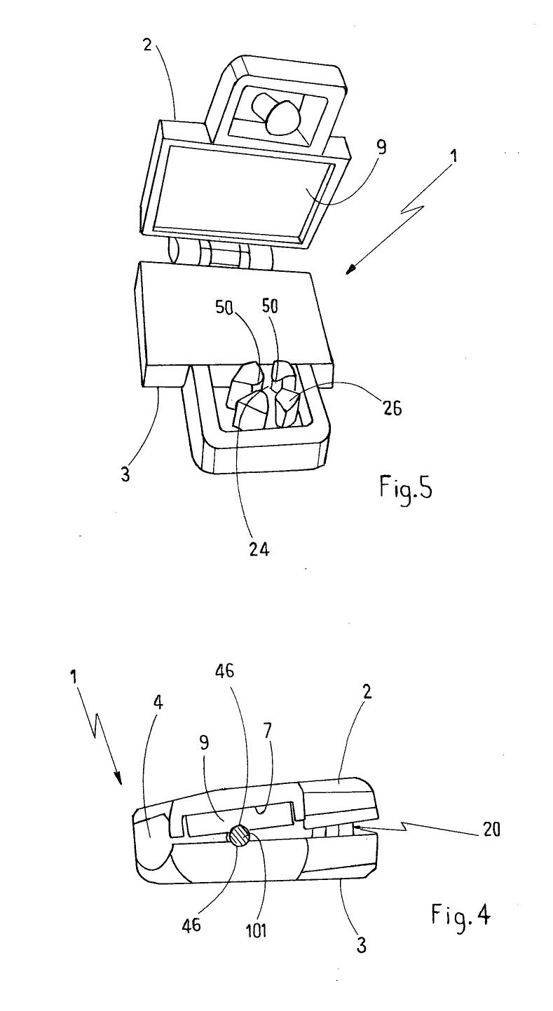

As is evident in the figures, the seats for the inserts in a pliable material are obtained on the two inner surfaces of the half shells 2 and 3, that is to say on those surfaces that after rotation of the half shells 2 and 3 around the axis X of the hinge 4, will be facing each other. As a result of the rotation of the half shells 2 and 3, the two inserts 9 will also be facing each other, inserted between the two shells 2 and 3, in a final sandwich structure (FIG. 2).

The antitheft device 1 also includes means to constrain the two half shells 2 and 3 together in a non-reversible manner. This means that once the antitheft device 1 is closed by said means, it is no longer possible to reopen it, other than by breaking said means and thus rendering the device 1 unserviceable for subsequent application on another pair of glasses.

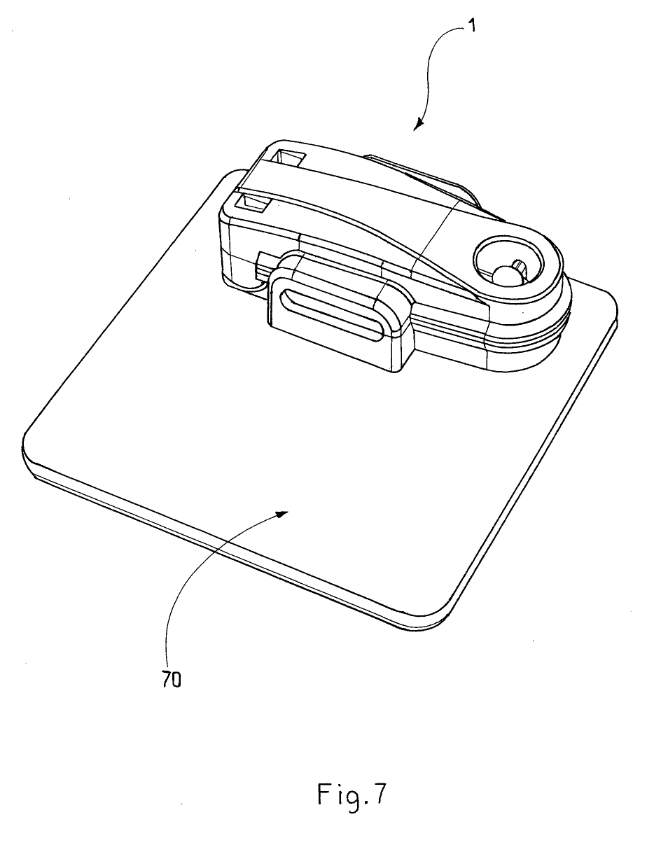

Said means to constrain the half shells 2 and 3 comprise one or more anchor elements 21 that can be coupled together by interference fitting. According to the preferred embodiment of the invention these anchor elements 21 are a pin 22, arranged on the half shell 2 and having at least one mushroom-shaped end 23 associable with at least one seat 24. Said seat 24 is instead arranged on the other half shell 3 and is provided with a deformable entrance end 25, able to accept the pin 22, and having smaller transversal dimensions than those of the free mushroom-shaped end 23 of the pin 22. As shown in FIGS. 1 and 5, the seat 24 comprises four elements 26 projecting from the half shell 3, the entry end 25 of which is equipped with a nose 50 arranged facing the inside of the seat. In this way, when the half shell 2 is drawn close to the half shell 3, the pin 22 is forced inside the seat 24. The entrance end 25 of the seat 24 deforms with the passage of the free mushroom-shaped end 23 of the pin 22 and then returns to the initial undeformed configuration as soon as the mushroom-shaped end 23 of the pin 22 is trapped in the seat 24. In fact, the four noses 26 present on the seat 24 prevent any reverse translation movement.

In use, the antitheft device 1 is closed over the arm 101 of a pair of glasses (not shown here). This operation can be carried out by hand or by using a tool, such as a pliers or similar (not shown here). The closure operation of the device 1 is carried out by bringing the two half shells 2 and 3 close to the arm 101 so that it finds itself between the two half shells 2 and 3, and placed between the hinge 4 and the means of constraint. The two half shells 2 and 3 are made to rotate around the axis X of the hinge 4 so that the outer faces 40 of the insert 9 are separately brought into contact with two surface portions 46 of the arm 101.

Subsequently, when the antitheft device 1 is completely closed on the arm 101 of the glasses 100, with the pin 22 inserted in the associated seat 24, the two inserts 9 find themselves flattened and compressed against the two surface portions 46 of the arm 101. The force of compression applied by the coupling of the means of constraint creates such a high level of friction between the pliable inserts 9 and the surface portions 46 of the arm 101 that it prevents any sliding whatsoever of the antitheft device 1 along the arm 101. In addition, the grip mechanism of the means of constraint is such as to prevent any opening whatsoever of the device 1 without causing it to break, effectively rendering the device unserviceable for any subsequent use. Furthermore, the outsides of two half shells 2 and 3 are made in a way to eliminate any engagement surface for a lever or any other tool that does not have the shape of the end able to force the two half shells 2 and 3 from the inside, passing through the apertures 60 and 61 present in correspondence to the means of constraint, and so opening the device 1 with the consequent breakage of the these means.

Therefore, to all intents and purposes, even if the glasses were stolen, the thief would not be able to remove the antitheft device 1 from the glasses other than by breaking the arm 101, with the obvious result of making the glasses themselves unserviceable.

According to a further embodiment of the invention not shown here, the device 1 is devoid of the hinge 4, while there are two pins 22 and two seats 24, associable with each other for the closure of the two half shells 2 and 3.

Basically, when the device 1 is closed around the arm 101, instead of reciprocally rotating one with respect to the other, the two half shells 2 and 3 are brought together in translation and, as in the previous case, pressed against each other, squashing the two inserts 9 against the arm 101 in correspondence to its surface portions 46, until the two pins 22 are completely inserted in the respective seats 24.

In the two solutions of the antitheft device 1 represented herein, the arm 101 of the glasses is kept clamped between the two elements made of a flexible material 9 without the possibility that, due to excessive pressures, the arm 101 can be scratched.

Instead, according to a third embodiment of the invention, the device 1 includes only one deformable insert arranged between the two half shells 2 and 3 (FIG. 5). In this case, when said two half shells are closed on the arm, the said pliable insert 9 presses on the portion 46 of said arm 101, which, in turn, is forced against the half shell 3.

It should be added that the anti-shoplifting device 1 can be provided with plaques on which if is possible to apply bar codes or other signalling systems suitable for electronic detection, directly positionable on additional seats obtained, for example, on the outside of the shells 2 and 3, so as to reinforce the antitheft functions of the device itself.

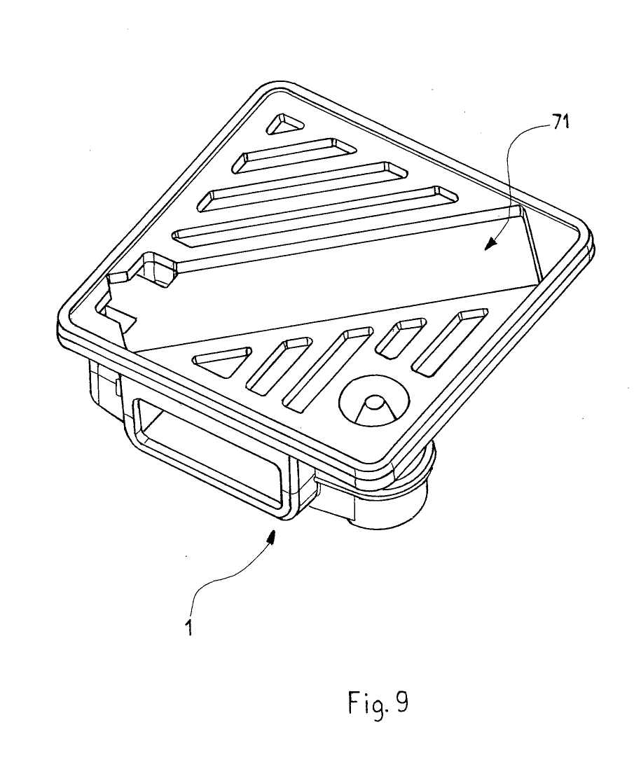

In particular, with reference to FIGS. 7 and 8, the device 1 is shown fitted with a plaque 70, seen in perspective in FIG. 7 and from below in FIG. 8, suitable for accommodating on its free upper and/or lower surface a tag or label, for example, with a bar code or another signalling system suitable for electronic detection. The plaque 70, always on its free surface, can also carry a label or similar containing various types of information concerning the product to which the device is fastened. FIG. 9 shows a similar plaque 71, see from below, which performs the same function as the plaque 70 illustrated in FIGS. 7 and 8. It should also be stated that the anti-shoplifting device 1 can have variable dimensions according to the type of glasses and/or arm 101 for which it is intended, without leaving the scope of protection of the present patent.

In addition, it can be observed that the simple and linear shape of the half shells 2 and 3 provided with two inserts 9 allows the device 1 to be made using a simple and rapid moulding method.

In fact, although the antitheft device 1 is composed of two different materials, namely a rigid material for the half shell 2 (or 3) and a flexible material for the insert 9, intended to accommodate the arm 101 of the glasses, each half of the device 1 can be manufactured in a single phase and obtained as a single finished piece. In practice, a moulded and assembled piece, comprising a half shell 2 (or 3), in a rigid material, and an insert 9 in a pliable material, comes directly out of the mould. Alternatively, as already stated, it will be possible to make the antitheft device 1 in a moulding phase and a subsequent assembly phase, which will allow the insert in a flexible material to be attached inside each half shell later on, via gluing or other similar systems.

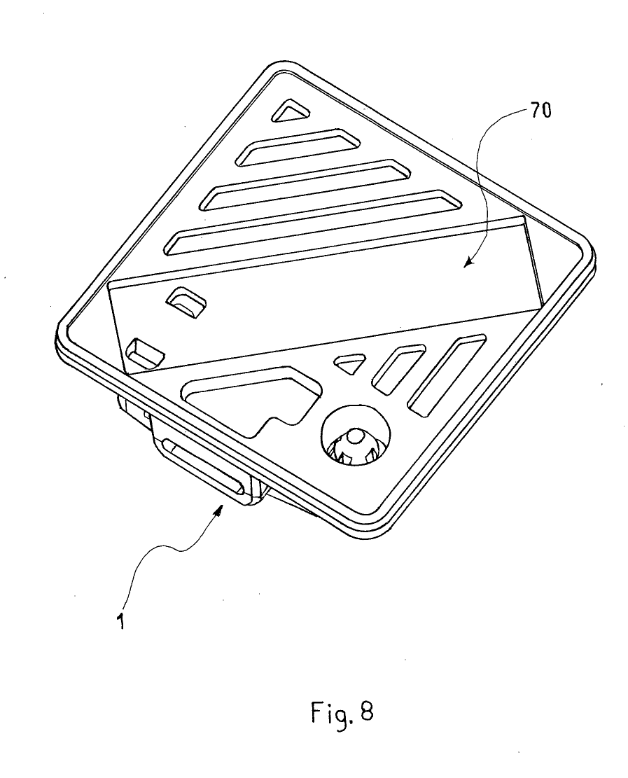

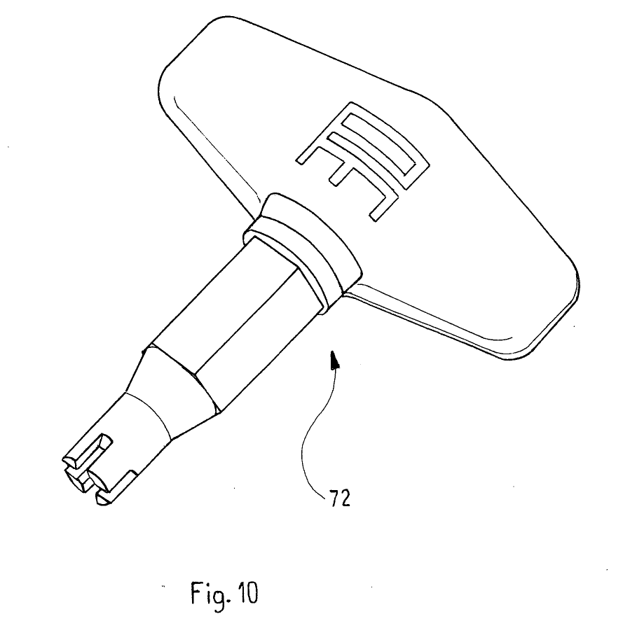

Similarly to FIG. 6, FIG. 10 shows a key 72 intended for opening the antitheft device 1.

Depending on the shape and characteristics of the pin 22 and its seat 24, the key shown in FIG. 10 in one of its possible embodiments, can be made with a shape suited to the purpose for which it is intended.

1. Antitheft device of the type to be mounted on the arm of a pair of glasses, comprising:
at least two rigid half shells able to close around the arm;
at least one half shell being provided with at least one insert in a pliable material able to accommodate, at least in part, a surface portion of the arm; and
means to constrain said at least two half shells to each other in a non-reversible manner.

2. Antitheft device according to claim 1, characterized in that said half shell and said insert are made in a single piece.

3. Antitheft device according to claim 1, characterized in that said half shell and said insert are made in two distinct pieces.

4. Antitheft device according to claim 1, characterized in that each half shell is provided with at least one insert in a pliable material.

5. Antitheft device according to claim 1, characterized in that said means to constrain said half shells to each other comprise one or more elements that can be coupled together by interference fitting.

6. Antitheft device according to claim 5, characterized in that said anchor elements comprise at least a mushroom-shaped pin arranged on a half shell, associable with at least one seat arranged on the other half shell, said seat being equipped with a deformable entrance end with smaller transversal dimensions than those of the end of the pin.

7. Antitheft device according to claim 6, characterized in that said seat comprises at least three elements, each fitted at the end with a nose that protrudes towards the inside of said seat.

8. Antitheft device according to claim 1, characterized in that said pliable insert is made of a material with a high coefficient of friction.

9. Antitheft device according to claim 1, characterized in that said at least two half shells are constrained to each other in a rotatable manner.

10. Antitheft device according to claim 1, characterized in that said half shells are made of a rigid material.

11. Antitheft device according to claim 1, characterized in that said inserts are made of rubber, silicone or an equivalent material.

12. Method for the manufacture of an antitheft device according to claim 1, characterized in that said half shell and said insert are made by moulding in a single main processing phase.

13. Method for the manufacture of an antitheft device according to claim 1, characterized in that said half shell and said insert are made by moulding and joined in accordance with separate processing phases.

14. Use of the device as per claim 1 as an antitheft device for sunglasses, spectacles and sports glasses.
